(19) United States
(12) Patent Application Publication
(10) Pub. No.: US 2001/0000253 A1
(43) Pub. Date: Apr. 12, 2001

(54) Hydrocarbon/acrylic hybrid resins for use in continuous ink jet ink formulations

(75) Inventor: Michael D. Matzinger, Charlotte, NC (US)

Correspondence Address: Daniel B. Reece IV, Westcavo Corporation, 5255 Virginia Avenue, Post Office Box 118005, Charleston, SC, 29423-8005, US

(73) Assignee: Westvaco Corporation, New York, NY (US)

(21) Appl. No.: 09/725,429

(22) Filed: Nov. 29, 2000

Related U.S. Application Data
(63) Continuation-in-part of application No. 09/315,623, filed on May 20, 1999.

(30) Foreign Application Priority Data
May 19, 2000 (EP) 00 401 377.7

(51) Int. Cl. C08L 55/00; C09D 11/10

(52) U.S. Cl. 523/160; 524/554

(57) ABSTRACT

The present invention relates to ink compositions for use in ink jet printers. More particularly, it relates to the use of hydrocarbon/acrylic hybrid resin compositions in solvent-based, continuous ink jet inks. The ink compositions demonstrate water and rub resistance properties while achieving excellent print quality, jetting properties, storage stability, reliability, and drying times.

1. This application is a continuation-in-part of my commonly assigned, co-pending U.S. patent application, Ser. No. 09/315,623 filed May 20, 1999, entitled “Hydrocarbon/Acrylic Hybrid Resins For Use In Continuous Ink Jet Ink Formulations”.

### FIELD OF INVENTION

2. The present invention relates to ink compositions for use in ink jet printers. More particularly, it relates to the use of hydrocarbon/acrylic hybrid resins in solvent-based, continuous ink jet inks. The ink compositions demonstrate water and rub resistance properties while achieving excellent print quality, jetting properties, storage stability, reliability, and drying times.

### BACKGROUND OF THE INVENTION

3. Ink jet printing involves placement, in response to a digital signal, of small drops of a fluid ink onto a surface to form an image without physical contact between the printing device and the surface. The method of drop generation varies among the different ink jet technologies and can be used to classify ink jet printing into two major technology types: continuous ink jet and drop-on-demand.

4. In continuous ink jet printing systems, to which the instant invention is directed, a continuous stream of liquid ink droplets is ejected from a nozzle and is directed, with the assistance of an electrostatic charging device in close proximity to the print head, either to a substrate to form a printed image or to a recirculating system. Inks for continuous ink jet printing systems typically are based on solvents such as methyl ethyl ketone and ethanol.

5. The following properties are required of an ink composition for ink jet printing:

6. (a) high quality printing (edge acuity and optical density) of text and graphics on substrates,

7. (b) short dry time of the ink on a substrate such that the resulting printed image is not smudged when rubbed or offset onto a subsequent printed image placed upon the print,

8. (c) good jetting properties exhibited by a lack of deviation of ink droplets from the flight path (misplaced dots) and of ink starvation during conditions of high ink demand (missing dots),

9. (d) resistance of the ink after drying on a substrate to water and to abrasion,

10. (e) long-term storage stability (no crust formation or pigment settling), and

11. (f) long-term reliability (no corrosion or nozzle clogging).

12. Inks are known that possess one or more of the above listed properties. However, few inks are known that possess all of the above listed properties. Often, the inclusion of an ink component meant to satisfy one of the above requirements can prevent another requirement from being met. For example, the inclusion of a polymer in the ink composition can improve the water and accent marker resistance of the ink on a substrate after drying. However, the polymer can cause flocculation or settling of the pigments and impair jetting properties and long-term storage stability. Thus, most commercial ink jet inks represent a compromise in an attempt to achieve at least an adequate response in meeting all of the above listed requirements.

13. Accordingly, an object of the present invention is to provide hydrocarbon/acrylic hybrid resin compositions suitable for use in ink jet printing ink formulations.

14. Another object of the present invention is to provide hydrocarbon/acrylic hybrid resins suitable for use in formulating ink compositions for ink jet printing with reduced water and accent marker sensitivity.

15. A further object of the present invention is to provide improved ink compositions capable of satisfying simultaneously the properties required of an ink composition for ink jet printing, especially the aforementioned properties (a) to (f).

16. Yet another object of the present invention is to provide an ink that has excellent filterability such that the ink can be filtered without ruining the filters.

17. Other objects, features, and advantages of the invention will be apparent from the details of the invention as more fully described and claimed.

### SUMMARY OF THE INVENTION

18. The objects of this invention are achieved by reacting carboxylic acid functionalized acrylic polymers with dicyclopentadiene and other hydrocarbon monomers to produce the desired hydrocarbon/acrylic hybrid resin compositions suitable for use in continuous ink jet ink formulations. Alternatively, the objects of this invention are also achieved by reacting carboxylic acid functionalized acrylic polymers with dicyclopentadiene and hydrocarbon resins and/or modified hydrocarbon resins to produce the desired hydrocarbon/acrylic hybrid resin compositions suitable for use in continuous ink jet ink formulations. Such continuous ink jet ink formulations have improved water and rub resistance properties, while achieving excellent print quality, jetting properties, storage stability, reliability, and drying times.

### DESCRIPTION OF THE PREFERRED EMBODIMENT

19. The hydrocarbon/acrylic hybrid resin composition for continuous ink jet ink formulations comprises the graft copolymer reaction product produced by reacting:

20. a) about 2% to about 63% by total weight of the reactants of dicyclopentadiene;

21. b) about 2% to about 63% by total weight of the reactants of a member selected from the group consisting of hydrocarbon monomers capable of undergoing polymerization with dicyclopentadiene and combinations thereof;

22. c) about 33% to about 96% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are capable of undergoing cycloaddition reaction with components a) and b); and

23. d) up to about 63% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;

24. at a temperature of from about 160° C. to about 300° C. for a time sufficient to produce the ink jet resin composition.

25. A preferred hydrocarbon/acrylic hybrid resin composition for continuous ink jet ink formulations comprises the graft copolymer reaction product produced by reacting:

26. a) about 10% to about 40% by total weight of the reactants of dicyclopentadiene;

27. b) about 10% to about 40% by total weight of the reactants of a member selected from the group consisting of hydrocarbon monomers capable of undergoing polymerization with dicyclopentadiene and combinations thereof;

28. c) about 40% to about 80% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are capable of undergoing cycloaddition reaction with components a) and b); and

29. d) up to about 40% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;

30. at a temperature of from about 220° C. to about 280° C. for a time sufficient to produce the ink jet resin composition.

31. Another hydrocarbon/acrylic hybrid resin composition for continuous ink jet ink formulations which is an object of the present invention comprises the graft copolymer reaction product produced by:

32. 1) reacting

33. a) about 2% to about 63% by total weight of the reactants of dicyclopentadiene;

34. b) about 2% to about 63% by total weight of the reactants of a member selected from the group consisting of hydrocarbon monomers capable of undergoing polymerization with dicyclopentadiene and combinations thereof; and

35. c) about 33% to about 96% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are capable of undergoing cycloaddition reaction with components a) and b);

36. at a temperature of from about 160° C. to about 300° C. for a time sufficient to produce a resin composition; and

37. 2) further reacting:

38. a) about 35% to about 98% by total weight of the reactants of said resin composition, and

39. b) about 2% to about 65% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;

40. at a temperature of from about 160° C. to about 300° C. for a time sufficient to produce the ink jet resin composition.

41. A preferred hydrocarbon/acrylic hybrid resin composition for continuous ink jet ink formulations comprises the graft copolymer reaction product produced by:

42. 1) reacting

43. a) about 10% to about 40% by total weight of the reactants of dicyclopentadiene;

44. b) about 10% to about 40% by total weight of the reactants of a member selected from the group consisting of hydrocarbon monomers capable of undergoing polymerization with dicyclopentadiene and combinations thereof; and

45. c) about 40% to about 80% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are capable of undergoing cycloaddition reaction with components a) and b);

46. at a temperature of from about 220° C. to about 280° C. for a time sufficient to produce a resin composition, and

47. 2) further reacting

48. b) about 50% to about 80% by total weight of the reactants of said resin composition, and

49. b) about 20% to about 50% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;

50. at a temperature of from about 220° C. to about 280° C. for a time sufficient to produce the ink jet resin composition.

51. A further hydrocarbon/acrylic hybrid resin composition for continuous ink jet ink formulations comprises the graft copolymer reaction product produced by reacting:

52. a) about 2% to about 63% by total weight of the reactants of dicyclopentadiene;

53. b) about 2% to about 63% by total weight of the reactants of a member selected from the group consisting of hydrocarbon resins, modified hydrocarbon resins, and combinations thereof;

54. c) about 33% to about 96% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are capable of undergoing cycloaddition reaction with components a) and b); and

55. d) up to about 63% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;

56. at a temperature of from about 140° C. to about 300° C. for a time sufficient to produce the ink jet resin composition.

57. A preferred hydrocarbon/acrylic hybrid resin composition for continuous ink jet ink formulations comprises the graft copolymer reaction product produced by reacting:

58. a) about 10% to about 40% by total weight of the reactants of dicyclopentadiene;

59. b) about 10% to about 40% by total weight of the reactants of a member selected from the group consisting of hydrocarbon resins, modified hydrocarbon resins, and combinations thereof;

60. c) about 40% to about 80% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are capable of undergoing cycloaddition reaction with components a) and b); and

61. d) up to about 40% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;

62. at a temperature of from about 180° C. to about 260° C. for a time sufficient to produce the ink jet resin composition.

63. A further hydrocarbon/acrylic hybrid resin composition for continuous ink jet ink formulations comprises the graft copolymer reaction product produced by:

64. 1) reacting

65. a) about 2% to about 63% by total weight of the reactants of dicyclopentadiene;

66. b) about 2% to about 63% by total weight of the reactants of a member selected from the group consisting of hydrocarbon resins, modified hydrocarbon resins, and combinations thereof; and

67. c) about 33% to about 96% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are capable of undergoing cycloaddition reaction with components a) and b);

68. at a temperature of from about 140° C. to about 300° C. for a time sufficient to produce a resin composition; and

69. 2) further reacting

70. a) about 35% to about 98% by total weight of the reactants of said resin composition, and

71. b) about 2% to about 65% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;

72. at a temperature of from about 140° C. to about 300° C. for a time sufficient to produce the ink jet resin composition.

73. A preferred hydrocarbon/acrylic hybrid resin composition for continuous ink jet ink formulations comprises the graft copolymer reaction product produced by:

74. 1) reacting

75. a) about 10% to about 40% by total weight of the reactants of dicyclopentadiene;

76. b) about 10% to about 40% by total weight of the reactants of a member selected from the group consisting of hydrocarbon resins, modified hydrocarbon resins, and combinations thereof; and

77. c) about 40% to about 80% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are capable of undergoing cycloaddition reaction with components a) and b);

78. at a temperature of from about 180° C. to about 260° C. for a time sufficient to produce a resin composition, and

79. 2) further reacting

80. a) about 50% to about 80% by total weight of the reactants of said resin composition, and

81. b) about 20% to about 50% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;

82. at a temperature of from about 180° C. to about 260° C. for a time sufficient to produce the ink jet resin composition.

83. Depending upon the characteristics desired, the hydrocarbon/acrylic hybrid ink jet resin compositions of the present invention can be formed via two differing methods. In one method, hydrocarbon/acrylic resins are formed by heating a mixture of hydrocarbon monomers (wherein one of the monomers is dicyclopentadiene), one or more acrylic resins and, optionally, specified additional chemical compounds to temperatures of from about 160° C. to about 300° C. (preferably from about 220° C. to about 280° C). The weight ratio of acrylic polymer to hydrocarbon monomers usually is about 2:1 to 1:45. The components are charged to a reactor which is then sealed and heated to a temperature within the desired range. The procedure generally is performed under an inert atmosphere by purging the charged reactor with nitrogen prior to sealing it. As the mixture is heated, an autogenous pressure of between 70 and 160 psig is usually generated. After maximizing, this pressure generally falls to between 40 and 70 psig as the polymerization proceeds. The reaction mixture is maintained at a temperature within the desired range under pressure for a period sufficient to achieve a hydrocarbon/acrylic hybrid resin possessing the desired properties. Typically a time of at least three hours is employed. Following this, the reactor is vented to reduce the pressure to 0 psig. Next, unreacted hydrocarbon monomers and inert compounds that would depress the softening point of the resin and give it an offensive odor are distilled from the reaction mixture. The removal of these materials is promoted by sparging the resin with nitrogen. Nitrogen is bubbled through the reaction mixture generally at a rate of 0.001 to 0.01 lb of N₂ per lb of reactants per hour. The length of this step is dependent on the desired properties of the resin but typically is conducted from one to ten hours.

84. Alternatively, in the second method hydrocarbon/acrylic resins of the present invention are formed by heating a mixture of dicyclopentadiene, one or more hydrocarbon-based resins, one or more acrylic resins and, optionally, specified additional chemical compounds to temperatures of from about 140° C. to about 300° C. (preferably from about 180° C. to about 260° C.). The weight ratio of acrylic polymer to dicyclopentadiene and hydrocarbon resins usually is about 10:1 to 1:30. The components are charged to a reactor which is then heated to a temperature within the desired range. The procedure generally is performed at atmospheric pressure; however, the reaction can be performed at an autogenous pressure. The reaction mixture is maintained at a temperature within the desired range for a period sufficient to bind the dicyclopentadiene and acrylic polymers together and to achieve a hydrocarbon/acrylic hybrid resin composition having the desired properties. Typically a period of time of at least two hours is employed.

85. Unexpectedly, the method by which the hydrocarbon/acrylic hybrid resin composition is prepared impacts the properties of the resin. That is, a different hybrid resin is obtained when the method of preparation is changed. Compared to the hybrid resins made according to the procedure of the first method, the hybrid resins of the second method are lower in softening point and molecular weight.

86. Hydrocarbon monomers suitable for producing the hybrid resin compositions must be capable of undergoing polymerization with dicyclopentadiene. The hydrocarbon monomer typically employed to make the hydrocarbon/acrylic hybrid resins is a technical grade dicyclopentadiene containing from about 75% to 85% dicyclopentadiene. Examples of such materials that are commercially available are DCPD 101 (a product of Lyondell Petrochemical) and DCP-80P (a product of Exxon). Other components in the dicyclopentadiene are inert hydrocarbons (such as toluene, xylenes and saturated hydrocarbons with from 4 to 6 carbons), and various codimers and cotrimers formed by the Diels-Alder condensation of butadiene, cyclopentadiene, methylcyclopentadiene, and acyclic pentadienes.

87. The above-noted hydrocarbon monomers may be employed in thermal polymerization reactions to produce hydrocarbon resins and modified hydrocarbon resins suitable for use in producing the hybrid resin compositions.

88. Likewise, aromatic hydrocarbons having a vinyl group conjugated to the aromatic ring may be employed to produce hydrocarbon resins and modified hydrocarbon resins suitable for use in producing the hybrid resin compositions. The vinyl aromatic compounds are incorporated into the growing dicyclopentadiene containing polymer by free radical addition to the vinyl group. Examples of such aromatic monomers are styrene, vinyl toluene, α-methyl styrene, β-methyl styrene, indene and methyl indene. Typically, hydrocarbon mixtures that contain from 50 to 100% of such compounds are used. Other components found in these mixtures are usually inert aromatic compounds, e.g., toluene, xylenes, alkylbenzenes and naphthalene. A commercially available example of such a mixture is LRO-90® (a product of Lyondell Petrochemical). A typical analysis of this materials is: xylene (1-5%), styrene (1-10%), α-methylstyrene (1-3%), β-methylstyrene (1-5%), methylindene (5-15%), trimethylbenzenes (1-20%), vinyltoluene (1-30%), indene (1-15%) and naphthalene (1-5%).

89. When incorporating vinyl aromatic monomers to produce hydrocarbon resins or modified hydrocarbon resins, the procedure for preparing the resin is the same. The vinyl aromatic component is added along with the dicyclopentadiene and other hydrocarbon monomer. The aromatic component is added to the reaction mixture in an amount less than the dicyclopentadiene used. Generally, the aromatic component is employed in an amount no greater than 30% by weight of the total reaction mixture. Preferably, the vinyl aromatic component is used from about 5 to 20% of the total reagent charge.

90. For both synthetic methods for producing the hybrid resin compositions, the amount of dicyclopentadiene monomer used in the preparation of the hydrocarbon/acrylic resin must be sufficient so as to provide at least one or more sites for the acrylic polymer to attach. Likewise, the acrylic polymer used in each method must have a sufficient number of acid sites so that at least one reaction with a dicyclopentadiene polymer can occur.

91. Although the mechanism of the reaction is not completely understood, it appears that an important aspect of the acrylic polymer is that the polymer possess: a) one or more carboxylic acid and/or carboxylic acid-precursor groups (i.e., be carboxylic acid functionalized), or b) that the polymer be both carboxylic acid functionalized and hydroxyl functionalized (i.e., also possess one or more hydroxyl and/or hydroxyl-precursor groups) . These chemical characteristics permit the acrylic polymer to react in a cycloaddition reaction with the norbornyl-type double bonds in the dicyclopentadiene resin. In this way the acrylic polymer is chemically bound (grafted) to the hydrocarbon polymer, thereby yielding a hydrocarbon/acrylic graft copolymer.

92. The mechanism of grafting employed in the present invention is the cycloaddition of a carboxyl group on a preformed acrylic polymer across a double bond (e.g., norbomenyl double bonds) of the hydrocarbon resin. The attachment of the acrylic resin occurs through an ester linkage in the cycloaddition graft, thereby allowing the acrylic chains to be attached to the hydrocarbon somewhere at mid-chain of the acrylic resin. The employment of this cycloaddition mechanism affords the user a great deal of flexibility in designing desired graft polymer structures.

93. Polymers that contain more than one acid group or hydroxyl group may be used and therefore are capable of reacting with more than one norbornyl-type double bond and acting as cross-linking agents between hydrocarbon polymer molecules. Furthermore, because the number of acid groups or hydroxyl groups on the acrylic polymer can be varied by changing the monomer composition, the crosslinking ability of the polymer can exceed that of modified rosin resins such as fumaric acid-adducted phenolic rosin resins, modified fatty acids such as maleic-anhydride-adducted linoleic acid, polyols such as pentaerythritol and sorbitol, polyamines such as 2-methylpentamethylene and hexamethylenediamine, polyaziridines such as IONACS® PFAZ-322 (supplied by Sybron Chemicals Inc.), DYTEK® A (supplied by from DuPont Company), and IONAC® PFAZ-322 (supplied by from Sybron Chemicals Inc.), and alkanolamines such as diethanolamine. The use of acrylic polymers with multiple acid groups or hydroxyl groups allows the preparation of hydrocarbon/acrylic resins with blends of viscosity, solubility and softening point properties that cannot be obtained by using resins with one or several acid groups or hydroxyl groups. For example, the use of multiple acid group-containing polymers or multiple hydroxyl group-containing polymers allows the synthesis of hydrocarbon/acrylic resins of molecular weight, viscosity, softening point, and efflux cup dilution properties higher than achievable using materials such as rosin and fatty acid and their derivatives.

94. Alcohols which are suitable for use in producing the hydrocarbon/acrylic ink jet resin compositions are members selected from the group consisting of alcohols capable of undergoing an insertion reaction across a norbornyl site, alcohols capable of undergoing an esterification reaction with an acid group, alcohols capable of undergoing an esterification reaction with an acid equivalent functional group, and combinations thereof. Alkyl amines which are suitable for use in producing the hydrocarbon/acrylic ink jet resin compositions are members selected from the group consisting of alkyl amines capable of undergoing an insertion reaction across a norbornyl site, alkyl amines capable of undergoing an esterification reaction with an acid group, alkyl amines capable of undergoing an esterification reaction with an acid equivalent functional group, and combinations thereof. Where desired, the molecular weight of the hydrocarbon/acrylic resin can be increased by treating the hydrocarbon/acrylic resin with a compound containing one or more functionalities from the group consisting of polyols, polyamines, polyaziridines, alkanolamines, polysulfides, and alkanolsulfides. Examples of polyols suitable for use in the present methods include pentaerythritol, glycerin, ethylene glycol, sorbitol, and the like. Examples of suitable polyamines include 2-methylpentamethylenediamine, bis(hexamethylene) triamine, 1,3-pentanediamine, and the like. Examples of suitable polyaziridines include IONAC® PFAZ-322 (supplied by Sybron Chemicals Inc.) and similar compounds. Examples of suitable polysulfides include glycerol dimercaptoacetate, pentaerythritol tetra(3-mercaptopropionate), trimethylolpropane trithioglycolate, polyethylene glycol dimercaptoacetate, and the like. Examples of suitable alkanolsulfides include glycerol monothioglycolate, monoethanolamine thioglycolate, 1-thioglycerol, and the like.

95. Specific examples of preferred carboxylic acid-functionalized acrylic polymers usable herein include a copolymer of styrene or a styrene derivative with acrylic acid or methacrylic acid. Styrene monomers usable herein include styrene, and further, styrene derivatives such as methylstyrene, dimethylstyrene, trimethylstyrene, α-chlorostyrene, α-methylstyrene, and the like. The copolymers may contain other monomers. Examples of other monomers include -unsaturated monomers including vinyl halides, vinyl esters, mono vinylidene aromatics, α,β-unsaturated carboxylic acids and esters thereof, -unsaturated dicarboxylic anhydrides, and mixtures thereof, and other monomers copolymerizable with styrene and (meth)acrylic acid. Polymerization methods are not particularly limited, and polymers having various monomer ratios are commercially available and may be used in the present invention.

96. Commercially available carboxylic acid-functionalized acrylic polymers include JONREZ® H-2700, H-2701, H-2702, and H-2704 (supplied by the Westvaco Corp.), JONCRYL® 678, 682, and 690 (supplied by S. C. Johnson, Inc.), MOREZ® 101 and 300 (supplied by Morton Int., Inc.), and VANCRYL® 65 and 68 (supplied by Air Products and Chemicals, Inc.). Commercially available hydroxyl-functionalized acrylic polymers include JONREZ® H-2703 (supplied by the Westvaco Corp.) and JONCRYL® 587 (supplied by S. C. Johnson, Inc.).

97. In a further embodiment of the invention, the hydrocarbon/acrylic resin may be reacted with α,β-unsaturated carboxylic acids, α,β-unsaturated carboxylic diacids, α,β-unsaturated carboxylic anhydrides, and the like. Examples of such carboxylic compounds which are suitable for use in producing the hydrocarbon/acrylic ink jet resin compositions of the present invention include those which are capable of undergoing an insertion reaction across a norbornyl site and/or an esterification reaction with an acid group or an acid equivalent functional group. Other carboxylic compounds which are suitable for use include those which are capable of Diels-Alder addition or ene reaction. Specific examples of such compounds include maleic anhydride, fumaric acid, itaconic acid, itaconic anhydride, crotonic acid, acrylic acid, methacrylic acid, and the like. These compounds react with the resin by a Diels-Alder addition or ene reaction, thus incorporating without loss of their carboxylic acid or anhydride functions. The reaction can be performed in the temperature range of 180-240° C., with the a range of 190-210° C. preferred. In general, from about 2 wt. % to about 15 wt. % of the α,β-unsaturated carboxylic acids, diacids or anhydrides can be added to the reaction mixture, but it is preferred that from about 4 wt. % to about 8 wt. % be used.

98. In a further embodiment of the invention, an α,β-unsaturated carboxylic acid, α,β-unsaturated carboxylic diacid, or α,β-unsaturated carboxylic anhydride can be incorporated into the hydrocarbon/acrylic hybrid resin during the polymerization reaction, thus incorporating without loss of their carboxylic acid or anhydride functions. Examples of such compounds are given in the previous paragraph. In general, from about 2 wt. % to about 40 wt. % of the α,β-unsaturated carboxylic acids, α,β-unsaturated carboxylic diacids, or a, -unsaturated carboxylic anhydrides can be added to the reaction mixture, but it is preferred that from about 4 wt. % to about 15 wt. % be used.

99. In a further embodiment of the invention, the hydrocarbon/acrylic resin may be reacted with fatty acids, fatty acid compounds, rosin acids, and/or rosin resins. Examples of such compounds which are suitable for use in producing the hydrocarbon/acrylic ink jet resin compositions of the present invention include those which are capable of undergoing an insertion reaction across a norbornyl site and/or an esterification reaction with an acid group or an acid equivalent functional group.

100. Fatty acids which are suitable for use in the present invention include, but are not limited to, the following: unsaturated fatty acids, saturated fatty acids, dimerized fatty acids, modified fatty acids, and combinations thereof. Suitable fatty acid compounds include the Diels-Alder cycloadducts and the ene-addition reaction products of unsaturated and polyunsaturated fatty acids with acrylic acid, acrylic acid derivatives, fumaric acid, and/or maleic anhydride.

101. In a further embodiment of the invention, rosin and rosin-based resins can be incorporated into the hydrocarbon/acrylic hybrid resin either during or after the polymerization reaction. Rosins suitable for this invention include tall oil rosin, gum rosin and wood rosin. Synthetic sources of these rosin acids may also be used. The modification of rosin with components such as phenols, α,β-unsaturated carboxylic acid, and polyols to produce rosin-based resins is a well established method for producing rosin-based resins. Examples of such suitable rosin-based resins are the JONREZ® RP-300, SM-700, IM-800, and HC-900 resin series (supplied by the Westvaco Corp.).

102. In a further embodiment of the invention, mononuclear phenols, polynuclear phenols, or phenol-based resins (i.e., novolacs or resoles) can be incorporated into the hydrocarbon/acrylic resin either during or after the polymerization reaction. Examples of such phenolic compounds which are suitable for use in producing the hydrocarbon/acrylic ink jet resin compositions of the present invention include those which are capable of undergoing an insertion reaction across a norbornyl site and/or an esterification reaction with an acid group or an acid equivalent functional group. These phenolic compounds can also be reacted with suitable aldehydes and/or aldehyde acetals either prior to or following the insertion reaction or esterification reaction. Among the phenolic compounds that can be used to modify the resin are phenol, bisphenol-A, para-tert-butylphenol, para-octylphenol, para-nonylphenol, para-dodecylphenol, para-phenylphenol, novolac resins such as HRJ-1166, HRJ-1367, SP-134, SP-560, SP-1068, SP-1077, and SRF-1524 (all supplied by Schenectady International, Inc.), resole resins, and mixtures thereof. Aldehydes which are suitable for use in the present invention include, but are not limited to, the following: paraformaldehyde, formaldehyde, and combinations thereof.

103. The hydrocarbon/acrylic hybrid ink jet resin compositions of this invention are characterized by acid number (ASTM D465-92) and softening point (ASTM E28-92). The units for acid number as reported here are mg KOH/gram of resin. Suitable acid numbers are less than 300 for continuous ink jet inks, preferably less than 120. Suitable softening points are from about 25° C. to about 210° C. for continuous ink jet ink resins, preferably 50° C. to 180° C. The above described properties of the resins of this invention can be controlled by the composition of the resin and the processing conditions.

104. As noted above, the hydrocarbon/acrylic hybrid resins can be utilized to produce continuous ink jet ink compositions with printing properties. Such ink compositions comprise the instant hydrocarbon/acrylic hybrid ink jet resin composition, a colorant, and a solvent system (carrier medium). It is preferred that the continuous ink jet ink compositions comprise:

105. (a) from about 1% to about 50% of one or more hydrocarbon/acrylic hybrid ink jet resin composition,

106. (b) from about 1% to about 20% of one or more colorant, and

107. (c) from about 30% to about 90% of a solvent system.

108. The ink compositions employed in the practice of the invention include a carrier medium comprised of at least one organic solvent. The carrier medium is present from about 30 to 90%, preferably from about 60 to 85% by weight, based on the total weight of the ink. A variety of solvents may be utilized. Suitable examples include: alcohols, such as methyl alcohol, ethyl alcohol, n-propyl alcohol, isopropyl alcohol, n-butyl alcohol, sec-butyl alcohol, or tert-butyl alcohol; amides, such as dimethylformamide or dimethylacetamide; carboxylic acids; esters, such as ethyl acetate, ethyl lactate, and ethylene carbonate; ethers, such as tetrahydrofuran or dioxane; glycerine; glycols; glycol esters; glycol ethers; ketones, such as acetone, diacetone, or methyl ethyl ketone; lactams, such as N-isopropyl caprolactam or N-ethyl valerolactam; lactones, such as butyrolactone; organosulfides; sulfones, such as dimethylsulfone; organosulfoxides, such as dimethyl sulfoxide or tetramethylene sulfoxide; and derivatives thereof and mixtures thereof. The principle carrier is typically a mixture of a lower ketone and a lower alcohol, each preferably having less than ten carbon atoms. Among these components, methyl ethyl ketone and ethanol are preferred.

109. The ink compositions typically contain at least one glycol that serves as a humectant to prevent drying of the compositions during the printing operation, as well as during storage of the compositions. Glycols suitably employed in the practice of the invention include ethylene glycol, diethylene glycol, triethylene glycol, tetraethylene glycol, propylene glycol, dipropylene glycol, glycerine, and polyethylene glycol. Polyethylene glycol is the preferred glycol. The humectant typically is present in an amount up to 30 percent by weight based on the weight of the composition, and preferably from about 2 to about 15 percent by weight.

110. The carrier media combinations used in the ink compositions must be compatible with the colorant so that flocculation or settling does not occur as a result of incompatibility. Also, the media combinations must be compatible with the materials of construction of the print head.

111. No particular limitation is imposed on the type or the amount of colorant used. Any pigment or dye that is soluble and dispersible in the solvent and is compatible with ink jet printing may be employed in the practice of the invention, and one skilled in the art will be able to ascertain such operable colorants. The amount of colorant employed in the practice of the invention is not critical and can be varied within relatively broad ranges. In general, the colorants are present in the composition in amounts varying from about 1 to about 20 percent and preferably from about 2 to about 10 percent, based on the weight of the ink compositions.

112. Polymers in addition to the hydrocarbon/acrylic hybrid resins of the present invention may be used. Methods of polymerization include solution, emulsion, suspension, and bulk polymerization. While physical properties of the polymers can be effected by the polymerization method, the resultant polymers can provide the desired outcomes of the invention. No particular limitation is imposed on the physical properties of the polymers. Preferred polymers are those having a weight average molecular weight in the range of from about 500 to 100,000, a softening point in the range of from about 25 to 150° C., and a glass transition temperature of less than 150° C. More preferred polymers are those having a weight average molecular weight in the range of from about 1000 to 20,000, a softening point in the range of from about 25 to 90° C., and a glass transition temperature of less than 90° C.

113. Suitable conductivity control components which optionally may be present include, among others, soluble ionizable salts such as alkali metals and alkaline earth metal halides, nitrates, thiocyanates, acetates, propionates, and amine salts. Example of such salts are potassium thiocyanate, tetraethylammonium chloride, and lithium nitrate. The salts are typically used in an amount of 0.1 to 3 percent by weight of the composition and preferably from about 0.5 to about 1.5 percent by weight.

114. The ink compositions of the present invention also may be formulated to include one or more surfactants to impart desirable characteristics to the liquid ink compositions. Preferred surfactants include non-ionic surfactants such as fluorinated alkyl esters such as FLUORAD® FC 430 (supplied by 3-M Company).

115. Consistent with the requirements of this invention, other agents may be incorporated in the ink composition such as agents to prevent intercolor bleed, anticurl and anticockle agents, antiseptic agents, biocides, chelating agents, corrosion inhibitors, desizing agents, mildewproofing agents, penetration promoters, pH adjusters and maintainers, pigment dispersants, resins, surface tension modifiers, and viscosity modifiers.

116. The inks of the present invention are particularly suited for use in continuous ink jet printers. Inks suitable for use in continuous ink jet printers should have a surface tension in the range of from about 20 to 70 dyne/cm, more preferably, in the range of from about 30 to 50 dyne/cm. The viscosity of the inks should be no greater than 20 cP at 25° C., and preferably below 12 cP. The inks must be stable to long term storage and to changes in temperature and relative humidity. In addition, they must dry quickly on the substrate but must not bleed through the substrate. The inks may be adapted to meet the requirements of a particular printer to provide a balance of optical density, water fastness, smear resistance, drying rate, light stability, chemical resistance, and cost. No limitation is placed on the order in which the components of the ink compositions are combined or the method in which they are combined.

117. There is no limitation placed on the recording medium used in conjunction with the above printing methods. Any suitable substrate can be employed, including conventional cellulosic papers such as copying paper and bond paper, silica coated papers, glass, aluminum, rubber, vinyl, fabrics, textile products, plastics, polymeric films, wood, and the like.

118. The following examples are provided to further illustrate the present invention and are not to be construed as limiting the invention in any manner. All parts are by weight unless otherwise stated.

### EXAMPLE 1

119. Into a one-liter autoclave reactor were charged 1401 parts of DCPD 101® (a dicyclopentadiene supplied by Lyondell Petrochemical Co.), 602 parts LRO-90® (a hydrocarbon mixture containing vinyl aromatic compounds supplied by Lyondell Petrochemical), 120 parts of NEODENE® 16 (a 1-hexadecene supplied by Shell Chemical Co.), and 100 parts JONREZ® H-2701 (a styrene/acrylic polymer having an acid number of 206 supplied by the Westvaco Corp.). The charged autoclave was purged with nitrogen and sealed. The reaction mixture was heated to 260° C. over a 90 minute period and was maintained at 260° C. for five hours. The reactor was then vented carefully, and the molten resin was poured into an aluminum pan and was allowed to cool.

120. Next, the resin was added to a one-liter, four-neck, round-bottom flask equipped with an electric heating mantle, overhead stirrer, thermocouple, nitrogen inlet tube, and Barret trap attached to a water-cooled condenser. The vessel was purged with nitrogen as the resin was heated to 220° C. At 220° C., the nitrogen inlet tube was immersed in the liquid resin and the nitrogen flow was adjusted to a rate of approximately 400 ml/min. The resin was sparged for two hours and then discharged into an aluminum pan.

121. The resulting hydrocarbon/acrylic hybrid ink jet resin composition had an acid number of 4, a glass transition temperature of 2° C., a weight average molecular weight of 5960 daltons, a Brookfield viscosity at 135° C. of 4780 cP, and a Ring and Ball softening point of 79° C.

### EXAMPLE 2

122. To a one-liter, four-neck, round-bottom flask equipped with an electric heating mantle, overhead stirrer, thermocouple, nitrogen inlet tube, and Barret trap attached to a water-cooled condenser were added 350 parts of the hybrid resin described in Example 1 and 40 parts maleic anhydride. The contents of the flask were heated to a temperature of 190° C. After five hours at 190° C., the resulting hydrocarbon/acrylic hybrid ink jet resin composition was collected in an aluminum pan. The resin had an acid number of 60, a weight average molecular weight of 7970 daltons, and a softening point of 121° C.

### EXAMPLE 3

123. An ink composition suitable for continuous ink jet printers was prepared by mixing 36.6 parts methyl ethyl ketone, 10 parts toluene, 10 parts isopropyl alcohol, 3 parts polyethylene glycol 300 (supplied by Aldrich Chemical Co.), 6 parts VALIFAST BLACK 3808 (a dye supplied by Orient Corporation of America), 2 parts potassium thiocyanate, 0.4 parts SURFYNOL® 104 PA (a surfactant supplied by Air Products, Inc.), 5 parts nitrocellulose, and 22 parts of the ink jet resin composition described in Example 2. The pH of the ink was 4.7. The ink has a viscosity of 15 cP (#1 Shell cup), a dynamic surface tension of 34.9 dynes/cm, and a conductivity of 0.71 mS/cm.

124. An ink formulated with the foregoing composition was drawn down with a No. 8 wire coated rod onto polyethylene. The resulting image possessed good resistance to scratching, water, and a 10% ethanol solution. The image was extremely uniform and free of mottling, crawling, or pinholing defects.

### EXAMPLE 4

125. Into a two-liter autoclave reactor were charged 1401 parts of DCPD 101® (a dicyclopentadiene supplied by Lyondell Petrochemical), 601 parts LRO-90® (a hydrocarbon mixture containing vinyl aromatic compounds supplied by Lyondell Petrochemical), 401 parts JONREZ® H-2704 (an acrylic polymer having an acid number of 44 supplied by the Westvaco Corp.), and 120 parts NEODENE® 16 (1-hexadecene supplied by Shell Chemical Co.). The charged autoclave was purged with nitrogen and sealed. The reaction mixture was heated to 275 ° C. over a two hour period and was maintained at 275° C. for three hours. The reactor was then vented carefully, and the molten resin was poured into an aluminum pan and was allowed to cool.

126. Next, the resin was added to a one-liter, four-neck, round-bottom flask equipped with an electric heating mantle, overhead stirrer, thermocouple, nitrogen inlet tube, and Barret trap attached to a water-cooled condenser. The vessel was purged with nitrogen as the resin was heated to 260° C. At 260° C., the nitrogen inlet tube was immersed in the liquid resin and the nitrogen flow was adjusted to a rate of approximately 400 ml/min. The resin was sparged for 30 minutes and then discharged into an aluminum pan.

127. The resulting light-orange hydrocarbon/acrylic hybrid ink jet resin composition had an acid number of 4, a Ring and Ball softening point of 78° C., a weight average molecular weight of 5860, and a glass transition temperature of 37.5° C.

### EXAMPLE 5

128. An ink composition suitable for continuous ink jet printers was prepared by mixing 50 parts methyl ethyl ketone, 20 parts ethanol, 3 parts diethylene glycol, 5 parts VALIFAST BLACK 3808 (a dye supplied by Orient Corporation of America), 2 parts tetraethyl ammonium bromide, and 20 parts of the ink jet resin composition described in Example 4. The pH of the ink was adjusted to 9.1 with ammonium hydroxide. The ink has a viscosity of 12.8 cP (#1 Shell cup), a dynamic surface tension of 36.5 dynes/cm, and a conductivity of 165 mΩ/cm.

129. An ink formulated with the foregoing composition was drawn down with a No. 8 wire coated rod onto polyethylene. The resulting image possessed good resistance to scratching, water, and a 10% ethanol solution. The image was extremely uniform and free of mottling, crawling, or pinholing defects.

### EXAMPLE 6

130. Into a one-liter autoclave reactor were charged 1400 parts of DCPD 101® (a dicyclopentadiene supplied by Lyondell Petrochemical), 600 parts LRO-90® (a hydrocarbon mixture containing vinyl aromatic compounds supplied by Lyondell Petrochemical) The charged autoclave was purged with nitrogen and sealed. The reaction mixture was heated to 260° C. over a one hour period and was maintained at 260° C. for five hours. The reactor was then vented carefully, and the molten resin was poured into an aluminum pan and was allowed to cool.

131. Next, the resin was added to a one-liter, four-neck, round-bottom flask equipped with an electric heating mantle, overhead stirrer, thermocouple, nitrogen inlet tube, and Barret trap attached to a water-cooled condenser. The vessel was purged with nitrogen as the resin was heated to 260° C. At 260° C., the nitrogen inlet tube was immersed in the liquid resin and the nitrogen flow was adjusted to a rate of approximately 400 ml/min. The resin was sparged for 30 minutes and then discharged into an aluminum pan.

132. To a one-liter, four-neck, round-bottom flask equipped with an electric heating mantle, overhead stirrer, thermocouple, nitrogen inlet tube, and Barret trap attached to a water-cooled condenser was added 150 parts of the resin and 76 parts of ROSIN SS (a tall oil rosin supplied by the Westvaco Corp.). The contents of the flask were heated to a temperature of 260° C. After three hours at 260° C., 20 parts of JONREZ(® H-2704 (an acrylic polymer having an acid number of 44 supplied by Westvaco Corp.) and 5 parts JONREZ® H-2703 (an acrylic polymer having a hydroxyl number of 90 supplied by Westvaco Corp.) were added and the temperature was maintained at 260° C. for two hours. After two hours at 260° C., the resulting hydrocarbon/acrylic hybrid ink jet resin composition was collected in an aluminum pan. The ink jet resin composition had an acid number of 4 and a softening point of 154° C.

### EXAMPLE 7

133. An ink composition suitable for continuous ink jet printers was prepared by mixing 36.6 parts methyl ethyl ketone, 10 parts toluene, 10 parts isopropyl alcohol, 8 parts polyethylene glycol 300 (supplied by Aldrich Chemical Co.), 6 parts Nigrosin dye (alcohol soluble), 2 parts potassium thiocyanate, 0.4 parts SURFYNOL® 104 PA (a surfactant supplied by Air Products, Inc.), 5 parts nitrocellulose, and 22 parts of the ink jet resin composition described in Example 6. The pH of the ink was adjusted to 9.9 with ammonium hydroxide. The ink has a viscosity of 12.8 cP (#1 Shell cup), a dynamic surface tension of 36.5 dynes/cm, and a conductivity of 165 mΩ/cm.

134. An ink formulated with the foregoing composition was drawn down with a No. 8 wire coated rod onto polyethylene. The resulting image possessed good resistance to scratching, water, and a 10% ethanol solution. The image was extremely uniform and free of mottling, crawling, or pinholing defects.

### EXAMPLE 8

135. Into a one-liter autoclave reactor were charged 1399 parts of DCPD 101® (a dicyclopentadiene supplied by Lyondell Petrochemical), 603 parts LRO-90® (a hydrocarbon mixture containing vinyl aromatic compounds supplied by Lyondell Petrochemical), 120 parts of NEODENE® 16 (a 1-hexadecene supplied by Shell Chemical Co.), and 402 parts JONREZ® H-2703 (a styrene/acrylic polymer having a hydroxyl value of 90 supplied by the Westvaco Corp.). The charged autoclave was purged with nitrogen and sealed. The reaction mixture was heated to 260° C. over a 90 minute period and was maintained at 260° C. for five hours. The reactor was then vented carefully, and the molten resin was poured into an aluminum pan and was allowed to cool.

136. Next, the resin was added to a one-liter, four-neck, round-bottom flask equipped with an electric heating mantle, overhead stirrer, thermocouple, nitrogen inlet tube, and Barret trap attached to a water-cooled condenser. The vessel was purged with nitrogen as the resin was heated to 220° C. At 220° C., the nitrogen inlet tube was immersed in the liquid resin and the nitrogen flow was adjusted to a rate of approximately 400 ml/min. The resin was sparged for two hours and then discharged into an aluminum pan.

137. The resulting hydrocarbon/acrylic hybrid ink jet resin composition had a weight average molecular weight of 1760 daltons and a Ring and Ball softening point of 81° C.

### EXAMPLE 9

138. An ink composition suitable for continuous ink jet printers was prepared by mixing 36.6 parts methyl ethyl ketone, 10 parts toluene, 23.3 parts isopropyl alcohol, 8 parts polyethylene glycol 300 (supplied by Aldrich Chemical Co.), 6 parts VALIFAST BLACK 3808 (a dye supplied by Orient Corporation of America), 2 parts potassium thiocyanate, 0.4 parts SURFYNOL® 104 PA (a surfactant supplied by Air Products, Inc.) 5 parts nitrocellulose, and 22 parts of the ink jet resin composition described in Example 8. The pH of the ink was adjusted to 6.6 with ammonium hydroxide. The ink has a viscosity of 13.4 cP (#1 Shell cup), a dynamic surface tension of 38.1 dynes/cm, and a conductivity of 0.67 mS/cm.

139. An ink formulated with the foregoing composition was drawn down with a No. 8 wire coated rod onto polyethylene. The resulting image possessed good resistance to scratching, water, and a 10% ethanol solution. The image was extremely uniform and free of mottling, crawling, or pinholing defects.

140. While the invention has been described and illustrated herein by references to various specific materials, procedures, and examples, it is understood that the invention is not restricted to the particular materials, combination of materials, and procedures selected for that purpose. Numerous variations of such details can be employed, as will be appreciated by those skilled in the art.

What is claimed is:

1. An ink jet resin composition for use in continuous ink jet ink formulations comprising the hydrocarbon/acrylic graft copolymer reaction product produced by reacting:
a) about 2% to about 63% by total weight of the reactants of dicyclopentadiene;
b) about 2% to about 63% by total weight of the reactants of a member selected from the group consisting of hydrocarbon monomers which undergo polymerization with dicyclopentadiene and combinations thereof;
c) about 33% to about 96% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are which undergo cycloaddition reaction with components a) and b); and
d) up to about 63% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;
at a temperature of from about 160° C. to about 300° C. for a time sufficient to produce the ink jet resin composition.

2. The ink jet resin composition of claim 1 which further comprises the hydrocarbon/acrylic graft copolymer reaction product produced by reacting:
a) about 10% to about 40% by total weight of the reactants of dicyclopentadiene;
b) about 10% to about 40% by total weight of the reactants of a member selected from the group consisting of hydrocarbon monomers which undergo polymerization with dicyclopentadiene and combinations thereof;
c) about 40% to about 80% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are which undergo cycloaddition reaction with components a) and b); and
d) up to about 40% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;
at a temperature of from about 220° C. to about 280° C. for a time sufficient to produce the ink jet resin composition.

3. The ink jet resin composition of claim 1 wherein said alcohol is a member selected from the group consisting of alcohols which undergo an insertion reaction across a norbornyl site, alcohols which undergo an esterification reaction with an acid group, alcohols which undergo an esterification reaction with an acid equivalent functional group, and combinations thereof.

4. The ink jet resin composition of claim 1 wherein said alkyl amine is a member selected from the group consisting of alkyl amines which undergo an insertion reaction across a norbornyl site, alkyl amines which undergo an esterification reaction with an acid group, alkyl amines which undergo an esterification reaction with an acid equivalent functional group, and combinations thereof.

5. The ink jet resin composition of claim 1 wherein said α,β-unsaturated carboxylic acid is a member selected from the group consisting of α,β-unsaturated carboxylic acids which undergo an insertion reaction across a norbornyl site, α,β-unsaturated carboxylic acids which undergo an esterification reaction with an acid group, α,β-unsaturated carboxylic acids which undergo an esterification reaction with an acid equivalent functional group, α,β-unsaturated carboxylic acids which undergo a Diels-Alder addition reaction, α,β-unsaturated carboxylic acids which undergo an ene-reaction, and combinations thereof.

6. The ink jet resin composition of claim 1 wherein said α,β-unsaturated carboxylic diacid is a member selected from the group consisting of α,β-unsaturated carboxylic diacids which undergo an insertion reaction across a norbornyl site, α,β-unsaturated carboxylic diacids which undergo an esterification reaction with an acid group, α,β-unsaturated diacids which undergo an esterification reaction with an acid equivalent functional group, α,β-unsaturated carboxylic diacids which undergo a Diels-Alder addition reaction, α,β-unsaturated carboxylic diacids which undergo an ene-reaction, and combinations thereof.

7. The ink jet resin composition of claim 1 wherein said α,β-unsaturated carboxylic anhydride is a member selected from the group consisting of α,β-unsaturated carboxylic anhydrides which undergo an insertion reaction across a norbornyl site, α,β-unsaturated carboxylic anhydrides which undergo an esterification reaction with an acid group, α,β-unsaturated anhydrides which undergo an esterification reaction with an acid equivalent functional group, α,β-unsaturated carboxylic anhydrides which undergo a Diels-Alder addition reaction, α,β-unsaturated carboxylic anhydrides which undergo an ene-reaction, and combinations thereof.

8. The ink jet resin composition of claim 1 wherein said fatty acid is a member selected from the group consisting of fatty acids which undergo an insertion reaction across a norbornyl site, fatty acids which undergo an esterification reaction with an acid group, fatty acids which undergo an esterification reaction with an acid equivalent functional group, fatty acids which undergo a Diels-Alder addition reaction, fatty acids which undergo an ene-reaction, and combinations thereof.

9. The ink jet resin composition of claim 1 wherein said fatty acid compound is a member selected from the group consisting of fatty acid compounds which undergo an insertion reaction across a norbornyl site, fatty acid compounds which undergo an esterification reaction with an acid group, fatty acid compounds which undergo an esterification reaction with an acid equivalent functional group, fatty acid compounds which undergo a Diels-Alder addition reaction, fatty acid compounds which undergo an ene-reaction, and combinations thereof.

10. The ink jet resin composition of claim 1 wherein said rosin acid is a member selected from the group consisting of tall oil rosin, gum rosin, wood rosin, and combinations thereof.

11. The ink jet resin composition of claim 1 wherein said mononuclear phenol is a member selected from the group consisting of mononuclear phenols which undergo an insertion reaction across a norbornyl site, mononuclear phenols which undergo an esterification reaction with an acid group, mononuclear phenols which undergo an esterification reaction with an acid equivalent functional group, and combinations thereof.

12. The ink jet resin composition of claim 1 wherein said polynuclear phenol is a member selected from the group consisting of polynuclear phenols which undergo an insertion reaction across a norbornyl site, polynuclear phenols which undergo an esterification reaction with an acid group, polynuclear phenols which undergo an esterification reaction with an acid equivalent functional group, and combinations thereof.

13. The ink jet resin composition of claim 1 wherein said resole is a member selected from the group consisting of resoles which undergo an insertion reaction across a norbornyl site, resoles which undergo an esterification reaction with an acid group, resoles which undergo an esterification reaction with an acid equivalent functional group, and combinations thereof.

14. The ink jet resin composition of claim 1 wherein said novolac is a member selected from the group consisting of novolacs which undergo an insertion reaction across a norbornyl site, novolacs which undergo an esterification reaction with an acid group, novolacs which undergo an esterification reaction with an acid equivalent functional group, and combinations thereof.

15. The ink jet resin composition of claim 1 wherein said aldehyde is a member selected from the group consisting of paraformaldehyde, formaldehyde, and combinations thereof.

16. A continuous ink jet ink composition comprising organic solvent, colorant, and the ink jet resin composition of claim 1.

17. An ink jet resin composition for use in continuous ink jet ink formulations comprising the hydrocarbon/acrylic graft copolymer reaction product produced by:
1) reacting
a) about 2% to about 63% by total weight of the reactants of dicyclopentadiene;
b) about 2% to about 63% by total weight of the reactants of a member selected from the group consisting of hydrocarbon monomers which undergo polymerization with dicyclopentadiene and combinations thereof; and
c) about 33% to about 96% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are which undergo cycloaddition reaction with components a) and b);
at a temperature of from about 160° C. to about 300° C. for a time sufficient to produce a resin composition; and
2) further reacting:
a) about 35% to about 98% by total weight of the reactants of said resin composition, and
b) about 2% to about 65% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;
at a temperature of from about 160° C. to about 300° C. for a time sufficient to produce the ink jet resin composition.

18. The ink jet resin composition of claim 17 which further comprises:
1) reacting
a) about 10% to about 40% by total weight of the reactants of dicyclopentadiene;
b) about 10% to about 40% by total weight of the reactants of a member selected from the group consisting of hydrocarbon monomers which undergo polymerization with dicyclopentadiene and combinations thereof; and
c) about 40% to about 80% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are which undergo cycloaddition reaction with components a) and b);
at a temperature of from about 220° C. to about 280° C. for a time sufficient to produce a resin composition, and
2) further reacting
b) about 50% to about 80% by total weight of the reactants of said resin composition, and
b) about 20% to about 50% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;
at a temperature of from about 220° C. to about 280° C. for a time sufficient to produce the ink jet resin composition.

19. A continuous ink jet ink composition comprising organic solvent, colorant, and the ink jet resin composition of claim 17.

20. An ink jet resin composition for use in continuous ink jet ink formulations comprising the hydrocarbon/acrylic graft copolymer reaction product produced by reacting:
a) about 2% to about 63% by total weight of the reactants of dicyclopentadiene;
b) about 2% to about 63% by total weight of the reactants of a member selected from the group consisting of hydrocarbon resins, modified hydrocarbon resins, and combinations thereof;
c) about 33% to about 96% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are which undergo cycloaddition reaction with components a) and b); and
d) up to about 63% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;
at a temperature of from about 140° C. to about 300 ° C. for a time sufficient to produce the ink jet resin composition.

21. The ink jet resin composition of claim 20 which further comprises reacting:
a) about 10% to about 40% by total weight of the reactants of dicyclopentadiene;
b) about 10% to about 40% by total weight of the reactants of a member selected from the group consisting of hydrocarbon resins, modified hydrocarbon resins, and combinations thereof,
c) about 40% to about 80% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are which undergo cycloaddition reaction with components a) and b); and
d) up to about 40% by total weight of the reactants of a member selected from the group consisting of alcohols having at least one hydroxyl group, alkyl amines having at least one amine group, metal salts of carboxylic acids, α,β-unsaturated carboxylic acids, α,βunsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof,
at a temperature of from about 180° C. to about 260° C. for a time sufficient to produce the ink jet resin composition.

22. A continuous ink jet ink composition comprising organic solvent, colorant, and the ink jet resin composition of claim 20.

23. An ink jet resin composition for use in continuous ink jet ink formulations comprising the hydrocarbon/acrylic graft copolymer reaction product produced by:
1) reacting
a) about 2% to about 63% by total weight of the reactants of dicyclopentadiene;
b) about 2% to about 63% by total weight of the reactants of a member selected from the group consisting of hydrocarbon resins, modified hydrocarbon resins, and combinations thereof, and
c) about 33% to about 96% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are which undergo cycloaddition reaction with components a) and b);
at a temperature of from about 140° C. to about 300° C. for a time sufficient to produce a resin composition; and
2) further reacting:
a) about 35% to about 98% by total weight of the reactants of said resin composition, and
b) about 2% to about 65% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;
at a temperature of from about 140° C. to about 300° C. for a time sufficient to produce the ink jet resin composition.

24. The ink jet resin composition of claim 23 which further comprises:
1) reacting
a) about 10% to about 40% by total weight of the reactants of dicyclopentadiene;
b) about 10% to about 40% by total weight of the reactants of a member selected from the group consisting of hydrocarbon resins, modified hydrocarbon resins, and combinations thereof; and
c) about 40% to about 80% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are which undergo cycloaddition reaction with components a) and b);
at a temperature of from about 180° C. to about 260° C. for a time sufficient to produce a resin composition, and
2) further reacting
a) about 50% to about 80% by total weight of the reactants of said resin composition, and
b) about 20% to about 50% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;
at a temperature of from about 180° C. to about 260° C. for a time sufficient to produce the ink jet resin composition.

25. A continuous ink jet ink composition comprising organic solvent, colorant, and the ink jet resin composition of claim 23.
